(19) United States
(12) Patent Application Publication
(10) Pub. No.: US 2023/0309475 A1
(43) Pub. Date: Oct. 5, 2023

(54) CUSTOMIZABLE HYDROPONIC GROWTH SYSTEM

(71) Applicant: IDAN HAKIA, RAMAT GAN (IL)

(72) Inventor: IDAN HAKIA, RAMAT GAN (IL)

(21) Appl. No.: 18/020,927

(22) PCT Filed: Aug. 17, 2021
(86) PCT No.: PCT/IL2021/050997

§ 371 Date: Feb. 11, 2023

(30) Foreign Application Priority Data
Aug. 18, 2020 (IL) 276782

(51) Int. Cl. A01G 31/02; A01G 29/00

(52) U.S. Cl. CPC A01G 31/02; A01G 29/00

(57) ABSTRACT

A customizable hydroponic growth system comprises a housing having a reservoir structure which is subdivided into a plurality of separate cells within each of which a different plant is receivable and hydroponically growable; and a cover covering the reservoir structure which is configured with a plurality of individually removable plant retainer sections, arranged such that each of said plant retainer sections is aligned with a corresponding one of said cells, wherein a first plant is removable from a first cell of the reservoir structure together with the plant retainer section with which is it retained while roots of the first plant are ensured of not being entangled with the roots of a second plant received in second cell of the reservoir structure which is adjacent to the first cell.

### FIELD OF THE INVENTION

The present invention relates to the field of hydroponic growth systems. More particularly, the invention relates to a compact and efficient hydroponic growth system, for promoting the customized cultivation of plants.

### BACKGROUND OF THE INVENTION

Hydroponically grown plants which are grown in an aqueous environment without soil require approximately 20% less space than plants grown in soil since the roots do not have to spread out within soil to search for nutrients and water-water and nutrients are delivered to the roots directly. Because less space is needed, the number of plants that may be grown per unit volume may be increased relative to conventional soil-grown techniques. Additionally, hydroponic plants have much utility in regions with scarce water resources as they require only approximately 5-10% of the water needed by their soil-grown counterparts, while being able to grow faster and to produce larger sized fruits since climate control and nutrient and water intake are able to be pinpointed.

However, there are various deficiencies associated with hydroponic growth system. Many hydroponic growth systems suffer from leakage resulting from malfunctioning valves, improperly connected joints, or blockage caused by a root mass, leading to reservoir overflow and the inability to control water usage. Also, hydroponic plants often have a nutrient deficiency or toxicity due to a rapid change in pH or in rate of absorption, the presence of disease, or excessive evaporation.

Additionally, most hydroponic growth systems are designed for indoor use, utilizing artificial illumination, pumps and climate control to emulate outdoor growth conditions. A major limitation for a hydroponic growth system is related to the relatively high costs involved in procuring and operating the artificial illumination elements. Another significant limitation is the dependency on electricity for powering the illumination elements, fluid flow elements and control elements; during a power or water outage, the plants being grown are at risk of root dehydration or even irreversible deterioration.

Furthermore, hydroponic systems are generally unsuitable for the growth of different types of plants at the same time since their roots become entangled as they grow, resisting the separation of plants one from another.

It is an object of the present invention to provide a customizable hydroponic growth system that is suitable for the growth of different types of plants or different sized plants at the same time within a same reservoir structure.

It is an object of the present invention to provide a customizable hydroponic growth system that is suitable for outdoor use to save the costs of artificial illumination elements while providing climate control.

It is an additional object of the present invention to provide a hydroponic growth system that is configured with leakage resistance.

It is an additional object of the present invention to provide a hydroponic growth system that automatically monitors and corrects system values in order to reliably produce high-yield plants.

It is yet an additional object of the present invention to provide a compact and cost effective hydroponic growth system.

Other objects and advantages of the invention will become apparent as the description proceeds.

### SUMMARY OF THE INVENTION

A customizable hydroponic growth system comprises a housing having a reservoir structure which is subdivided into a plurality of separate cells within each of which a different plant is receivable and hydroponically growable; and a cover covering the reservoir structure which is configured with a plurality of individually removable plant retainer sections, arranged such that each of said plant retainer sections is aligned with a corresponding one of said cells, wherein a first plant is removable from a first cell of the reservoir structure together with the plant retainer section with which is it retained while roots of the first plant are ensured of not being entangled with the roots of a second plant received in second cell of the reservoir structure which is adjacent to the first cell.

In one aspect, the system further comprises a control system having a plurality of components retained in the housing which are configured to automatically achieve climate control for either indoor or outdoor use with respect to user-selected settings.

In another aspect, the control system comprises plant growth optimization components.

In yet another aspect, one of the plant growth optimization components is an electrolysis unit for generating root-beneficial oxygen without any heat influx to a hydroponically exposable root zone.

In a further aspect, one of the plant growth optimization components is a fogger for producing a mist ensuring that a seedling will receive a sufficient amount of water needed to induce germination and seedling phases of growth.

In another aspect, the plant growth optimization components include an imaging system for monitoring the root zone and a machine learning module configured to help distinguish between healthy and unhealthy roots.

In still another aspect, the electrolysis unit is controlled in response to reservoir water temperature readings detected by a water temperature sensor.

In one aspect, one of the plant growth optimization components is a capacitive sensor for detecting a water level within the reservoir with respect to predetermined set values, without risk of root entanglement.

In another aspect, the control system is configured to obtain data related to a plant-specific vapor pressure deficit and to set a nutrient feeding schedule in response to the obtained data.

According to an embodiment of the invention, each of the cells is delimited by one of more external vertically oriented walls of the reservoir structure and by one or more internally located and vertically oriented partitions.

According to an embodiment of the invention, each of the partitions is made of a meshed or porous material to keep the roots from the first and second plants untangled and separated, while being exposed to circulating reservoir water.

According to an embodiment of the invention, each of the partitions extends downwardly to a horizontal meshed root divider to which dead roots are able to gravitate while being prevented from passing through apertures formed in the root divider.

### BRIEF DESCRIPTION OF THE DRAWINGS

In the drawings:

FIG. 1A is a perspective view from the top and side of an embodiment of a portable hydroponic plant growth housing;

FIG. 1B is a perspective view from the side of the housing of FIG. 1A when one of the side walls is removed, showing flow control components;

FIG. 2 is a perspective view from the side of the housing of FIG. 1A, showing a plant being removed therefrom;

FIG. 3A is a perspective view from the top of the housing of FIG. 1A while the upper surface thereof is removed;

FIG. 3B is a vertical sectional view cut through the housing of FIG. 1A;

FIG. 3C is a perspective view from the top of the housing of FIG. 1A while the upper surface thereof is removed, shown with the addition of an electrolysis unit;

FIG. 3D is a perspective view from the top and side of the housing of FIG. 1A while the upper surface thereof is removed, shown with addition of a fogger;

FIG. 4 is a perspective view from the side of the housing of FIG. 1A, showing various plant supports attached thereto;

FIGS. 5A-B are two exploded views, respectively, of the housing of FIG. 1A; and

FIG. 5C is a perspective view from the side of the housing of FIG. 1A when one of the side walls is removed, showing additional flow control components.

### DETAILED DESCRIPTION OF THE INVENTION

The customizable hydroponic growth system is user-friendly and reliable, being suitable for home cultivation of plants, whether for indoor or outdoor use and with a user-selected combination of repositionable plant types. Alternatively, the hydroponic growth system may be used for the commercial growth of plants. An automated control system optimizes the conditions for growing each plant.

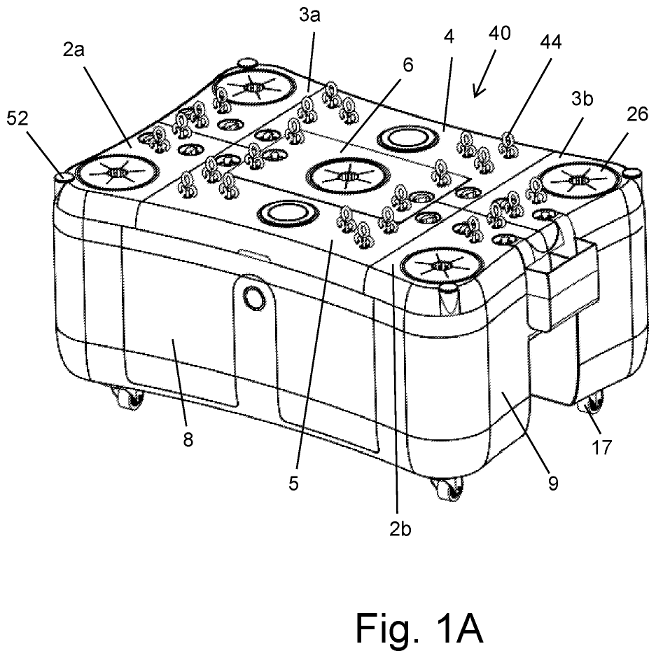

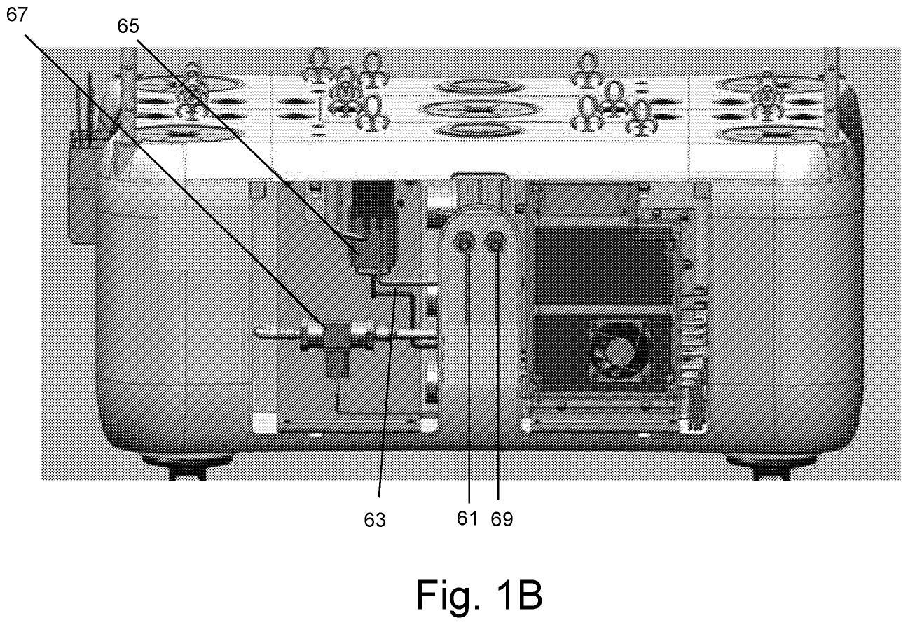

FIG. 1A illustrates an embodiment of a portable hydroponic plant growth housing 40. Housing 40, which may be rectilinear and covered, is subdivided into a plurality of separate cells, within each of which a different plant is able to be individually grown. Control circuitry and components are mounted within the housing in order to monitor system values and to provide climate control.

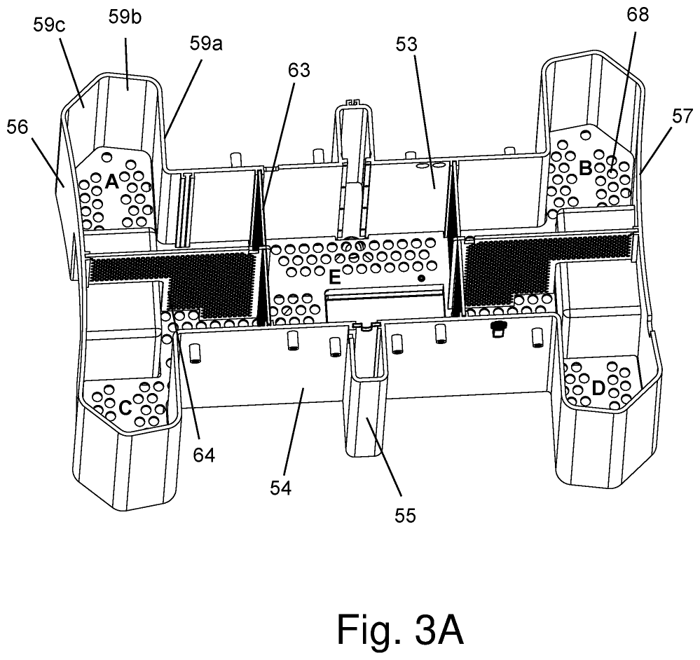

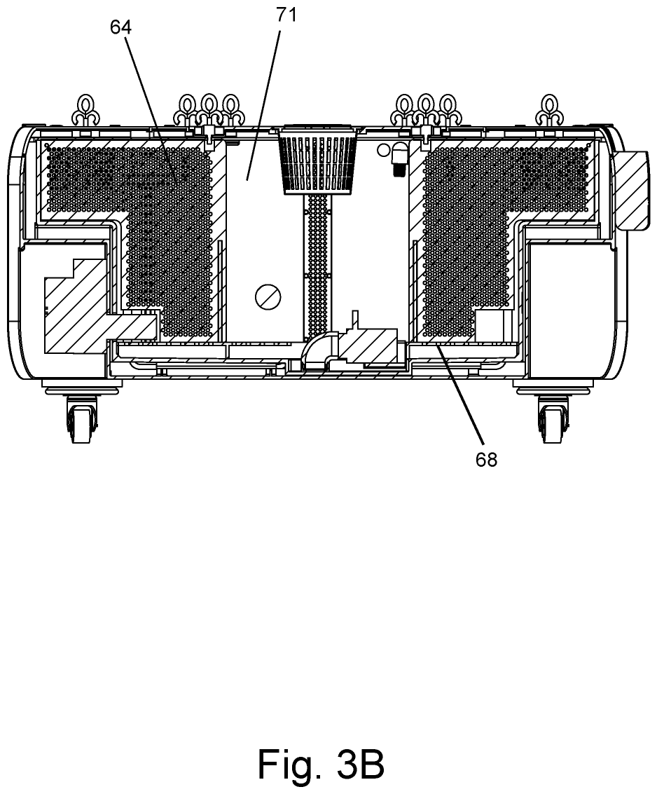

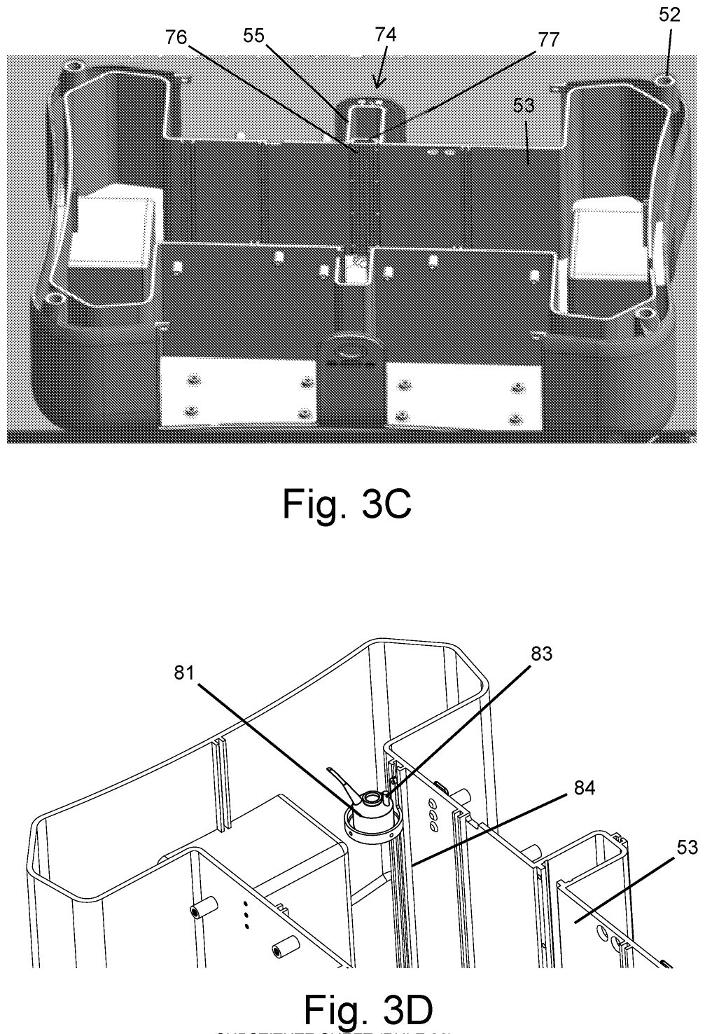

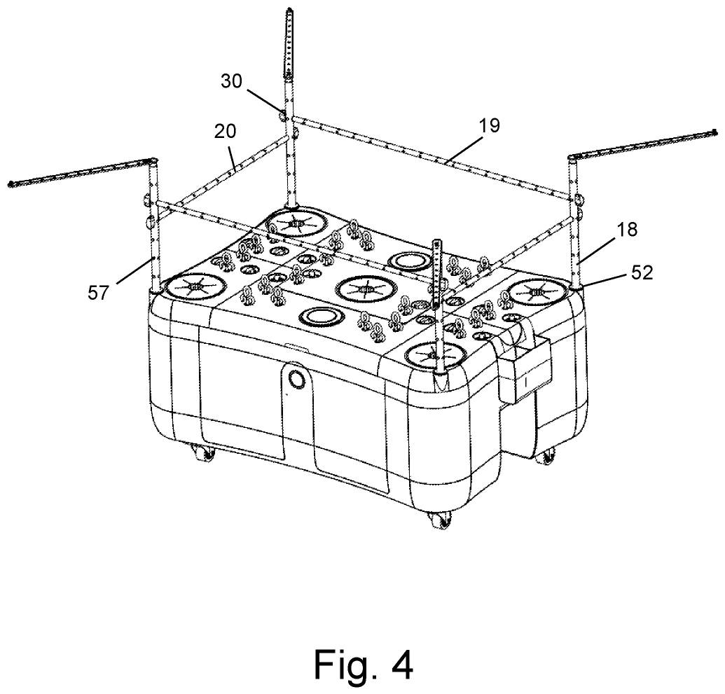

Housing 40 has a reservoir 9 within which water is fillable and circulatable. Reservoir 9 may have an I-shaped horizontal cross section, as shown in FIG. 3A, while opposed vertically oriented, planar closures, which may be pivotable about a horizontal axis, supplement the configuration of reservoir 9 to provide the rectilinear shape. Closure 8 covers a plurality of externally mounted nutrient bottles from which a pH-regulating solution is dischargeable. An electric box within which is housed the control circuitry is covered by the opposed closure.

As shown in FIG. 1B, when one of the closures is removed, water is introducible to the reservoir from a water source via inlet port 61, an inlet solenoid valve (not shown) and conduit 63, in response to the operation of water pump 65, which may be self-priming and whose suction end is in liquid communication with conduit 63. The water circulating within the reservoir is discharged by means of a discharge pump (not shown) and outlet solenoid valve 67 via outlet port 69.

Although the water volume within reservoir 9 varies, depending on the selected size of housing 40, the number of plants to be grown, as well as on other factors, a typical water volume that is collected within reservoir 9 is 40 L, while the water level of the collected water is located approximately 8 cm below the upper surface of the housing.

To promote the portability of housing 40, a plurality of wheels 17, e.g. four caster wheels, are provided to facilitate simple repositioning of the housing, for example from indoor use to outdoor use. Despite the fluctuations in temperature and solar irradiation to which the housing is exposed during outdoor use, the walls of the reservoir and of the closures may be double-sided and insulated, in order to isolate the collected water, control circuitry and nutrient bottles from the solar irradiation.

An upper thin and planar surface adapted for accommodating the growth of individual plants is provided at the top of reservoir 9. The upper surface is defined by two symmetric U-shaped sections 4 and 5, a central plant retainer section 6 interposed between U-shaped sections 4 and 5, and corner plant retainer sections 2a-b and 3a-b, each of which located at the corner of the upper surface and adjacent to a U-shaped section. Each of the corner plant retainer sections 2a-b and 3a-b may be configured with a socket 52.

Each of the plant retainer sections 2a-b, 3a-b and 6 is configured with a slotted disc-shaped cup 26 through which the plant extends when it grows. Cup 26, which is frictionally engaged with the complementary wall of the corresponding plant retainer section, is also engaged with a cylindrical slotted mesh basket located therebelow within which a plant is able to grow hydroponically. The basket generally contains a neutral and porous growing medium such as rockwool that retains oxygen and the nutrient-rich moisture that the roots need to grow, and also enables the roots to support the weight of the plants and to be held upright. The hydroponic growth system is suitable for use in conjunctions with various hydroponic methods such as the ebb and flow method whereby the plant roots are periodically flooded, the nutrient film technique (NFT) whereby suspended roots are in contact with a shallow film of nutrient solution flowing along an inclined grow tray to absorb the nutrients without being soaked and an upper root portion is exposed to oxygen of the surrounding ambient air, and the low-maintenance deep water culture (DWC) method providing roots that are suspended in a well-oxygenated solution composed of water and nutrients. One or more tie-downs 44 protrude upwardly from each of sections 2a-b, 3a-b and 4-6, or alternatively from one or more of sections 2a-b, 3a-b and 4-6. By employing the tie-downs 44, plant shoots are able to be attached to a tie-down and to grow horizontally. The plant is therefore exposed to improved light penetration, thus promoting greater plant yield.

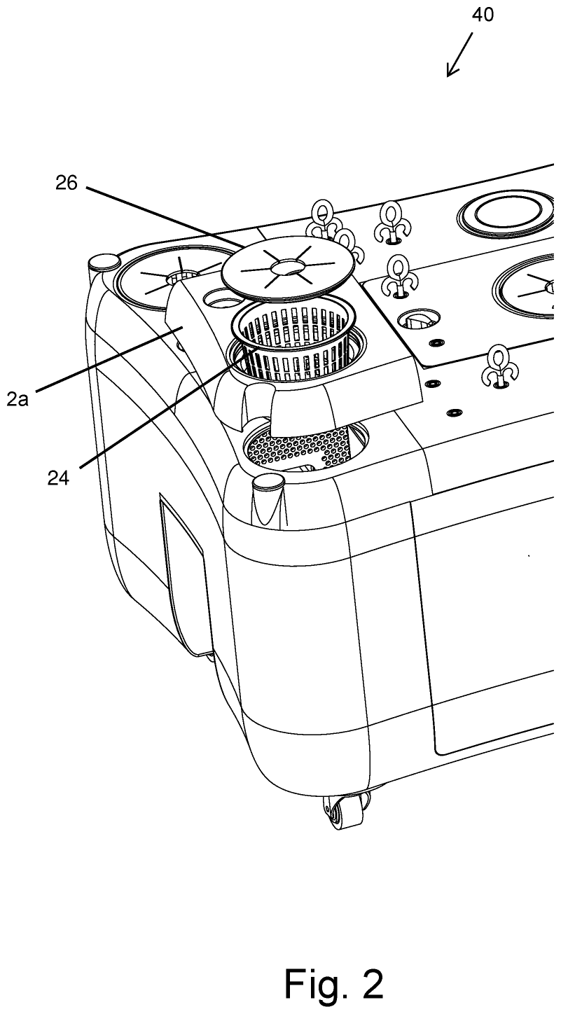

As shown in FIG. 2, the subdivision of housing 40 into a plurality of separate cells is advantageous in that an entire plant is able to be removed without interfering with the growth of another plant. By simply raising a plant retainer section, such as plant retainer section 2a, the mesh basket 24 and plant grown therewithin are also raised and removed from the housing. Consequently, a plant found to be dying may be simply removed from the housing together with all of its roots. Also, the relative position of a plant within the housing may be replaced in order to improve the plant's rate of growth, in order for example to be exposed to better light or climatic conditions.

The plurality of cells A-E provided by housing 40 are illustrated in FIG. 3A. Each of the cells is delimited by external vertically oriented walls of the reservoir and by a plurality of internally located, vertically oriented partitions. For example, cell A is delimited by wall 53 defining the web of the I-shaped reservoir and parallel to opposed wall 54, end wall 56 being substantially perpendicular to, and spaced from, walls 53-54 and substantially parallel to opposed end wall 57, a group of angled walls 59a-c extending from wall 53 to 56 to define a U-shaped volume, partition 63 extending perpendicularly from an intermediate region of wall 53 corresponding to approximately a quarter of its length, and partition 64 extending from partition 63 to a central region of end wall 56. A hollow protruding section 55 opening to the reservoir may protrude outwardly from, and be continuous with, each of walls 53 and 54.

It will be appreciated that any other housing configuration is within the scope of the invention.

The partitions 63 and 64 extend downwardly from the upper edge of the walls proximate to the upper surface of the housing to a horizontal meshed root divider 68, also shown in FIG. 3B, which is located at the bottom of the reservoir, serving to separate dead roots from healthy roots located in water of a healthy root zone 71 located above root divider 68. The healthy roots pass through apertures formed in root divider 68. Root divider 68 is of particular utility when the DWC hydroponic method is employed, and dead roots that become separated from healthy roots float in the oxygenated body of water, which generally undergoes circulation, to minimize mixing of the water in contact with the dead roots with the water located in the healthy root zone 71. The dead roots and other residue tend to gravitate within the healthy water zone towards root divider 68 and are prevented from passing through the apertures formed in root divider 68. The dead roots may be advantageously decomposed via an enzyme additive, such as Cannazym, manufactured by Canna BV, the Netherlands, which is able to be fed automatically into the reservoir by peristaltic pumps and even converted to minerals and sugars that are beneficial to the plants. The partitions, which may be made of a meshed or porous material such as a net, serve to keep the roots from two different plants untangled and separated, while allowing each plant to be individually removed from the housing without damaging the roots of the other plants.

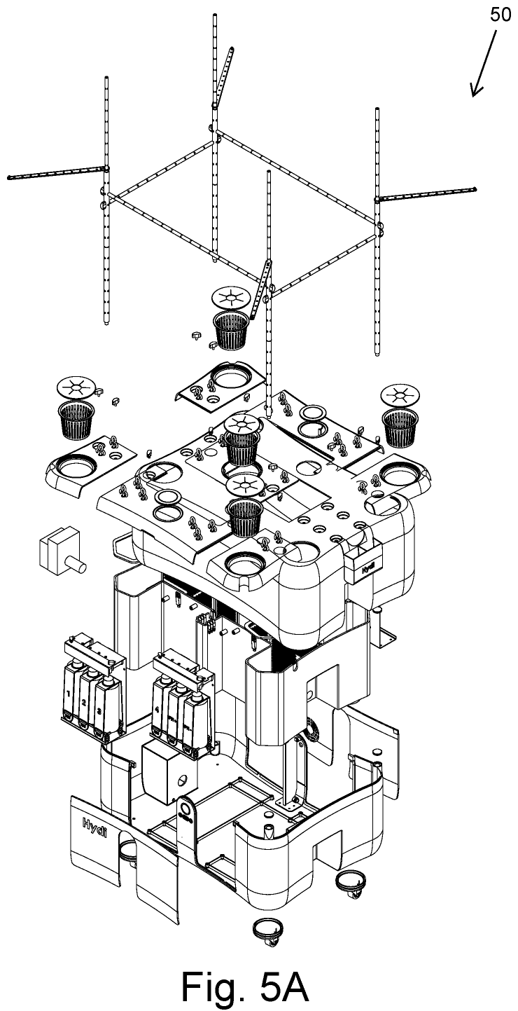

To support the plants when increased in size, a pole 18 is received in each corresponding socket 52, as shown in FIG. 4. The poles 18, which are able to support a corresponding plant shoot, are configured with a plurality of vertically spaced through-holes 57, so that a horizontal bar 19 or 20 passes through two corresponding through-holes 57 of adjacent poles 19, thereby assembling a stable structure. The end of bar may be secured to a corresponding pole by means of a wing knob 30. A net may be draped on the poles 18 to produce an even canopy level and improved light penetration. By separating the plant shoots by poles 18, the plants are consequently exposed to additional sunlight, thus increasing the yield significantly. Indicators may be applied, e.g. adhesively applied, to each pole, to provide a gradation mark that indicates the current height of the shoot.

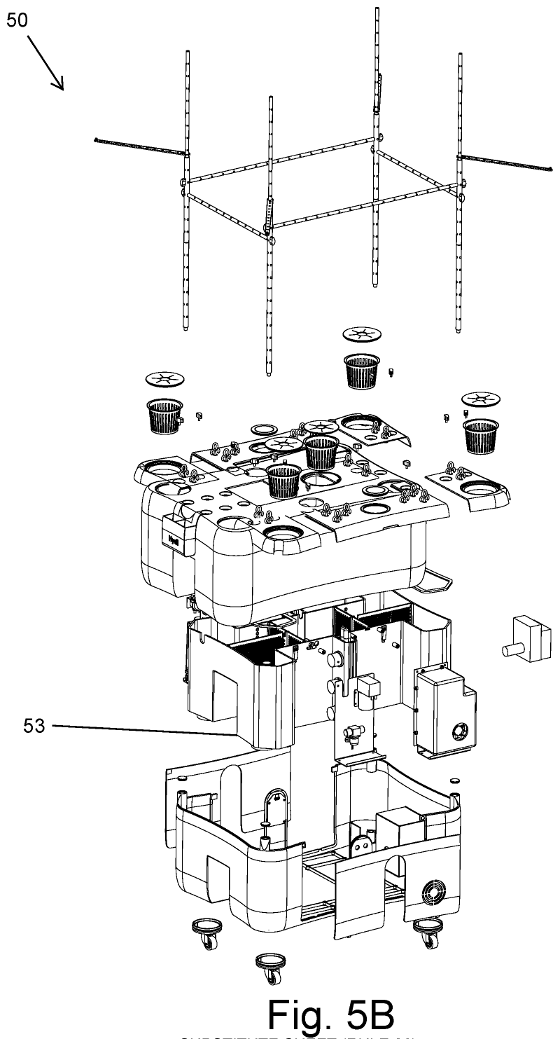

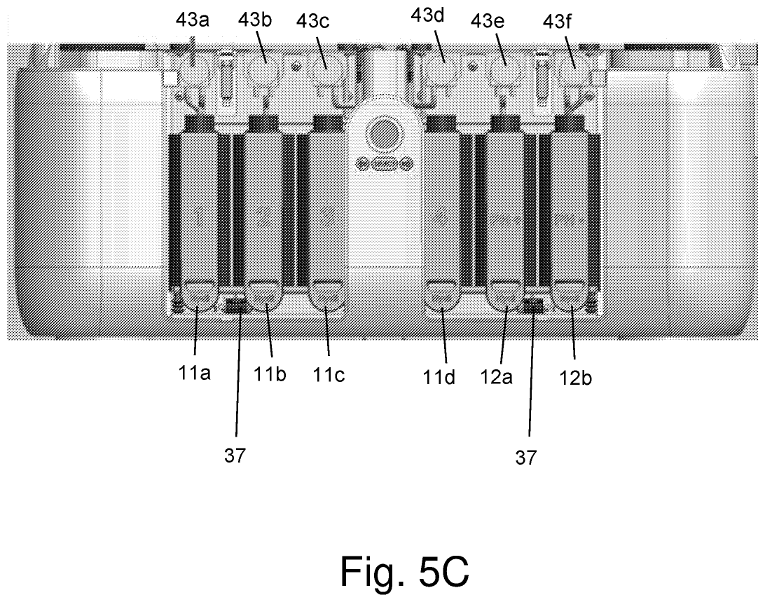

FIGS. 5A-B illustrate an exploded view of the housing, showing various components that may operate in conjunction with hydroponic growth system 50. Each component can easily be replaced if found to be malfunctioning while minimizing deterioration of the plants being grown and avoiding their removal from the housing. Component removal may be carried out with use of a simple one-way connector, which is able to be removed after deactivation of the electrical power fed to the housing, or by any other means well known to those skilled in the art.

The following are some of the components:
1. Inlet solenoid valve, which is activated when fresh water is introduced into the reservoir. The inlet solenoid valve may be opened to introduce fresh water when the mid water level sensor is not sensing water.
2. Discharge pump, by which water is discharged from the reservoir via water outlet 69 (FIG. 1B). For example, a submersible pump can be located within the reservoir. When there is a command of discharging the reservoir, both the discharge pump and the outlet solenoid valve are activated, causing the reservoir water to be discharged to an external location.
3. Outlet solenoid valve 67, which is opened in conjunction with the discharge pump in order to empty the reservoir or to adjust the pH level within the reservoir water, if an excessive amount of nutrients have been added thereto.
4. Thermoelectric water chiller and heater 35, which is activated or deactivated in response to a temperature value detected by temperature sensor 31. This component is advantageously small and reliable and lacks any moving parts with the exception of a quiet DC fan.
5. A small-sized and quiet electrolysis unit 74 (FIG. 3C) for generating a large volume of oxygen needed by the roots, without any heat added to the root zone and without any moving parts, as opposing to a conventional air pump. Electrolysis unit 74 is configured with a cathode 76, e.g. a stainless steel cathode, which is fit in the protruding section of housing wall 53 so as to be substantially continuous therewith, an anode 77, e.g. a platinum anode, which is received within the interior of protruding section 55, and a power supply (not shown) to produce a potential difference between cathode 76 and anode 77. The reservoir water constitutes the electrolyte, and means are provided to cause flow of the reservoir water between between cathode 76 and anode 77 within protruding section 55, to ensure electrolysis and the resulting generation of oxygen. It should be noted that the amount of the dissolved oxygen concentration is highly dependent on the temperature of the water. When using traditional methods such as air stones and venturi aerators, the generated air bubbles tend to simply exit directly out of the water. While using electrolysis, in contrast, the generated air bubbles are sufficiently small such that they remain submerged within the water and will not break through the water surface, thus considerably increasing the oxygen concentration within the water. For example, traditional methods are able to provide an oxygen concentration of up to 8 mg/L, while electrolysis unit 74 is advantageously able to provide up to 12 mg/L or more. The hydroponic growth system may be configured to activate or deactivate the electrolysis unit when the reservoir is empty and additional water needs to be introduced. For example, a 1 hour ‘ON’ super charge time may supercharge the water to 12 mg/L when water temperature is at 19° C., and after supercharge, cycles of 20 min on/40 min off will maintain the dissolved oxygen at sufficient levels.
6. A fogger 81 is shown in FIG. 3D, and is used to produce a mist so that a seedling will receive the necessary amount of water within the first couple of weeks of growth that is needed to induce the germination and seedling phases of growth, without need of dripping hoses that become clogged and occupy considerable space. Fogger 81 is connected to a movable fogger holder 83, which is adapted to be secured at a desired height of a vertical rail 84 provided at one of the reservoir walls.
7. An imaging system (not shown) comprises a set of cameras for monitoring the healthy root zone 71 (FIG. 3B) within the reservoir and a machine learning module to help distinguishing between healthy and unhealthy roots and to learn why specific root related issues are caused. Plants or young seedlings are able to be illuminated by means of a plurality of light elements, such as 360-degree LED elements, mounted on a pole that is insertable within a corresponding socket 52 (FIG. 3C) at an upper corner of the housing. UV sterilizing light elements, e.g. at a wavelength of 220 nm, may be used as well to sterilize various components of the hydroponic growth system.
8. A plurality of peristaltic pumps 43 shown in FIG. 5C for delivering nutrient from nutrient bottles 11 and 12 which are mounted on housing wall 54 to the reservoir water. Rotating lobes of each of the peristaltic pumps 43 compress a flexible tube receiving the nutrient solution from a corresponding nutrient bottle to force the fluid to be pumped through the tube and into the reservoir. The peristaltic pumps selectively operate for approximately 2 seconds after the nutrients are fed slowly, and are then deactivated for several minutes to allow the nutrient-enriched water to circulate completely within the reservoir. In the illustrated example, the hydroponic growth system comprise six peristaltic pumps 43a-f; pumps 43a-d serving to deliver nutrient bottles 11a-d, respectively, each of which containing a different nutrient or additive, pump 43e serving to deliver the solution contained in bottle 12a adapted to increase the pH of the reservoir water, and pump 43f serving to deliver the solution contained in bottle 12b adapted to decrease the pH of the reservoir water.
9. A bottle shaker 37 shown in FIG. 5C employing one or more motors for shaking nutrient bottles 11 and 12 in order to maintain homogeneity of the nutrients, in response to operation of the peristaltic pumps. The bottle shaker 37 may operate 2 minutes prior to the operation of the peristaltic pumps.
10. Indoor mounted components for emulating outdoor growth conditions, such as environmental components including one or more of a humidifier, dehumidifier, air conditioner, and fans, and light elements.
11. WiFi connectors and/or any other suitable wireless protocols, such as WiFi smart plugs, for interfacing with each of the indoor mounted components.
12. Electric box 14 in which is housed the control circuitry is mounted on housing wall 53 and adjacent to valve support 13. The control circuitry includes a main controller which commands the operation of these components in response to signals received from various sensors. Sensor readings are taken proximate to housing wall 53 while nutrients are delivered from a location proximate to opposite housing wall 54, allowing the concentrated nutrients after being discharged from the nutrient bottles to become diluted to a plant-beneficial level that is worthy to be monitored.

The following sensors may be included in hydroponic growth system 50, in order to communicate relevant signals to the main controller:
(a) pH sensor 32 for measuring the acidity of the reservoir water so that the main controller will command the delivery of acidic nutrients or basic nutrients so that the proper pH needed will be maintained;
(b) electrical conductivity (EC) sensor 33 for measuring the concentration of nutrients within the reservoir water, while the peristaltic pumps will pump the desired amount of nutrients needed to reach a specific EC needed for all the plants. In this embodiment, the system commonly maintains the pH level and the EC level for all the plants together;
(c) water temperature sensor 31, accurate determination of the reservoir water temperature of the water being critical in order to ensure that the plants obtain a sufficiently high amount of oxygen needed for improved plant growth and the elimination of root zone problems. It should be noted that water temperature and oxygen levels are correlated, such that the water is able to hold more dissolved oxygen as the water temperature is lower. Warmer water also has the added side effect of being a breeding ground for bacteria and fungus that are harmful to plants;
(d) capacitive sensors for detecting the water level within the reservoir with respect to predetermined set values, without risk of root entanglement and the need to penetrate the reservoir with openings to accommodate level switches as conventionally practiced, to facilitate automatic filling and draining of the reservoir in conjunction with the solenoid valves and pumps;
(e) environmental, humidity and temperature sensors for sensing and logging data related to the environment in which the plants grow, whereby the vapor pressure deficit (VPD) may be obtained by reverse calculation; VPD, being defined as the difference between the amount of moisture in the air and how much moisture the air can hold when it is saturated, is indicative of how much water the plant needs to draw from its roots and is an important measurement that can be used to initiate operation of the indoor environmental components and to set an appropriate nutrient feeding schedule tailored to a specific micro-growth environment. An example how VPD is calculated is described in further detail hereinafter;
(f) dissolved oxygen sensor for measuring the oxygen level in the water; and
(g) weight sensors for weighing the plant-loaded housing in order to determine how specific plant strains are developing by obtaining the rate of growth as well as other data and comparing the obtained data with data derived from other plants hydroponically growing all over the world; a machine learning module may be used to interface with the obtained data. For example, the hydroponic growth system may comprise four weight sensors, one located at each corner of the underside of the housing and slightly spaced from a corresponding wheel 17 (FIG. 1A).

For example, to get accurate (100-200 grams range) results:

Net plant weight=S−T−W−B,

### Where:

S=Sensor output
T=Total weight of the machine without water
F=Total weight of the machine with full water tank and nutrient bottles+accessories.
W=full water tank and bottles
B=Nutrients used. Can be calculated via run-time of each peristaltic pump.
   (Taken each time when High level water sensor is turned on)

### Calculating VPD

The VPD metric consists of air temperature, leaf temperature, and relative humidity. It can be measured in Kilopascals, Millibars and PSI. To find out how aggressively the environment is pulling air from the plant, we must compare the difference between the plants' Saturated Vapour Pressure (which we know, if we know the temperature of the leaf) and the vapor pressure of the air (VPsat−VPair). To get VPsat, we must know the temperature of the saturated environment, in this case, the leaf of the plant. In our system is placing the humidity and temperature sensor at canopy level close to the plant.

The formula for VPsat (in Kilopascals kPa) is:

$$VPsat = \frac{610.7 \cdot {10}^{( 7.5 T ) / ( 237.3 + T )}}{1000}$$

Where T is leaf Temperature in Celsius

To get VPair, we must know the temperature and humidity of the air, known together as relative humidity. We may measure this with the system's sensors.

The formula for VPair (in Kilopascals kPa) is:

$$VPsat = \frac{610.7 \cdot {10}^{( 7.5 T ) / ( 237.3 + T )}}{1000} \cdot \frac{RH}{100}$$

Where T is air Temperature in Celsius and RH is Relative Humidity

To Get VPD, we need to subtract the actual vapor pressure of the air from the saturated vapor pressure (VPsat−VPair).

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1-12. (canceled)

13. A customizable hydroponic growth system, comprising a housing having a reservoir structure which is subdivided into a plurality of separate cells within each of which a different plant is receivable and hydroponically growable; and a cover covering the reservoir structure which is configured with a plurality of individually removable plant retainer sections, arranged such that each of said plant retainer sections is aligned with a corresponding one of said cells, wherein a first plant is removable from a first cell of the reservoir structure together with the plant retainer section with which is it retained while roots of the first plant are ensured of not being entangled with the roots of a second plant received in second cell of the reservoir structure which is adjacent to the first cell, wherein said customizable hydroponic growth system is adapted to operate in conjunction with various components that can easily be replaced if found to be malfunctioning while minimizing deterioration of the plants being grown and avoiding their removal from the housing, wherein access to components of the system is enabled due to the structure of the reservoir in which some of the separate cells form wider portions while other cells form a narrow portion.

14. The hydroponic growth system according to claim 13, further comprising a control system having a plurality of components retained in the housing which are configured to automatically achieve climate control for either indoor or outdoor use with respect to user-selected settings.

15. The hydroponic growth system according to claim 14, wherein the control system comprises plant growth optimization components.

16. The hydroponic growth system according to claim 15, wherein one of the plant growth optimization components is an electrolysis unit for generating root-beneficial oxygen without any heat influx to a hydroponically exposable root zone.

17. The hydroponic growth system according to claim 15, wherein one of the plant growth optimization components is a fogger for producing a mist ensuring that a seedling will receive a sufficient amount of water needed to induce germination and seedling phases of growth.

18. The hydroponic growth system according to claim 15, wherein the plant growth optimization components include an imaging system for monitoring the root zone and a machine learning module configured to help distinguish between healthy and unhealthy roots.

19. The hydroponic growth system according to claim 16, wherein the electrolysis unit is controlled in response to reservoir water temperature readings detected by a water temperature sensor.

20. The hydroponic growth system according to claim 15, wherein one of the plant growth optimization components is a capacitive sensor for detecting a water level within the reservoir with respect to predetermined set values, without risk of root entanglement.

21. The hydroponic growth system according to claim 14, wherein the control system is configured to obtain data related to a plant-specific vapor pressure deficit and to set a nutrient feeding schedule in response to the obtained data.

22. The hydroponic growth system according to claim 13, wherein each of the cells is delimited by one of more external vertically oriented walls of the reservoir structure and by one or more internally located and vertically oriented partitions.

23. The hydroponic growth system according to claim 22, wherein each of the partitions is made of a meshed or porous material to keep the roots from the first and second plants untangled and separated, while being exposed to circulating reservoir water.

24. The hydroponic growth system according to claim 22, wherein each of the partitions extends downwardly to a horizontal meshed root divider to which dead roots are able to gravitate while being prevented from passing through apertures formed in the root divider.
